(19) United States
(12) Patent Application Publication
(10) Pub. No.: US 2026/0277480 A1
(43) Pub. Date: Sep. 17, 2026

(54) MEMORY DEVICE, OPERATING METHOD THEREFOR, AND MEMORY SYSTEM

(71) Applicant: Yangtze Memory Technologies Co., Ltd., Wuhan (CN)

(72) Inventors: Jianjie LI, Wuhan (CN); Wei HUANG, Wuhan (CN); Weijun WAN, Wuhan (CN)

(21) Appl. No.: 19/414,454

(22) Filed: Dec. 10, 2025

(30) Foreign Application Priority Data
Mar. 14, 2025 (CN) 202510307447.1

(51) Int. Cl. G06F 3/06

(52) U.S. Cl. CPC G06F 3/0659; G06F 3/0604; G06F 3/0679

(57) ABSTRACT

Implementations of the present disclosure provide a memory device, a memory system, and an operating method for the memory device. The memory device includes a memory cell array and a peripheral circuit coupled to the memory cell array. The peripheral circuit is configured to: perform a first read operation and a first read restore operation in sequence in response to receiving a first read command; receive a second read command in response to completing the first read operation; and perform a second read operation in response to receiving the second read command.

### CROSS-REFERENCE TO RELATED APPLICATIONS

This application claims priority to Chinese Patent Application No. 202510307447.1, filed on March 14, 2025, which is hereby incorporated by reference in its entirety.

### TECHNICAL FIELD

The present disclosure relates to the field of semiconductor technologies, and more particularly, to a memory device, a memory system, and an operating method for the memory device.

### BACKGROUND

Memory devices may include semiconductor devices and may include nonvolatile memories that retain stored data even after power is turned off. For example, nonvolatile memories may be widely used in systems of computers, cellular phones, smart phones, personal digital assistants, and other electronic devices. The read speed and the read efficiency are improved by optimizing the peripheral circuit configuration and the operating method for the memory device.

### SUMMARY

In a first aspect, a memory device is provided in the implementations of the present disclosure. The memory device includes a memory cell array and a peripheral circuit coupled to the memory cell array. The peripheral circuit is configured to: perform a first read operation and a first read restore operation in sequence in response to receiving a first read command; receive a second read command in response to completing the first read operation; and perform a second read operation in response to receiving the second read command.

In an exemplary implementation, the second read operation includes a second read preparation operation and a second read sensing operation, and the peripheral circuit is further configured to: perform the second read preparation operation and the second read sensing operation in sequence in response to receiving the second read command, where a process of performing the first read restore operation partially overlaps with a process of performing the second read preparation operation.

In an exemplary implementation, the peripheral circuit is further configured to: determine a first indicator signal, where the first indicator signal remains at a first level in a process of performing the first read operation and the second read operation and changes from the first level to a second level when the first read operation is completed, and the first indicator signal changes from the second level to the first level when the receiving of the second read command is completed.

In an exemplary implementation, the peripheral circuit is further configured to: receive the second read command in response to the first indicator signal changing from the first level to the second level.

In an exemplary implementation, the peripheral circuit is further configured to: perform a second read restore operation after performing the second read operation.

In an exemplary implementation, the first level is lower than the second level.

In an exemplary implementation, the peripheral circuit is further configured to: determine a second indicator signal, where the second indicator signal remains at a third level in a process of performing the first read operation, the first read restore operation, the second read operation, and the second read restore operation and changes from the third level to a fourth level when the second read restore operation is completed.

In an exemplary implementation, the third level is lower than the fourth level.

In a second aspect, a memory system is provided in the implementations of the present disclosure. The memory system includes a memory device mentioned in any of the implementations above and a controller, where the controller is coupled to the memory device and is configured to control the memory device.

In a third aspect, an operating method for a memory device is provided in implementations of the present disclosure. The operating method for the memory device includes: performing a first read operation and a first read restore operation in sequence in response to receiving a first read command; receiving a second read command in response to completing the first read operation; and performing a second read operation in response to receiving the second read command.

In an exemplary implementation, the second read operation includes a second read preparation operation and a second read sensing operation, and performing the second read operation in response to receiving the second read command includes: performing the second read preparation operation and the second read sensing operation in sequence in response to receiving the second read command, where a process of performing the first read restore operation partially overlaps with a process of performing the second read preparation operation.

In an exemplary implementation, the operating method further includes: determining a first indicator signal, where the first indicator signal remains at a first level in a process of performing the first read operation and the second read operation and changes from the first level to a second level when the first read operation is completed, and the first indicator signal changes from the second level to the first level when the receiving of the second read command is completed.

In an exemplary implementation, receiving the second read command in response to completing the first read operation includes: receiving the second read command in response to the first indicator signal changing from the first level to the second level.

In an exemplary implementation, the first level is lower than the second level.

In an exemplary implementation, the operating method further includes: performing a second read restore operation after performing the second read operation.

In an exemplary implementation, the operating method further includes: determining a second indicator signal, where the second indicator signal remains at a third level in a process of performing the first read operation, the first read restore operation, the second read operation, and the second read restore operation and changes from the third level to a fourth level when the second read restore operation is completed.

In an exemplary implementation, the third level is lower than the fourth level.

### BRIEF DESCRIPTION OF THE DRAWINGS

Other features, objects, and advantages of the present disclosure will become more apparent by reading the detailed description of non-limiting implementations made with reference to the following drawings. In the drawings:

FIG. 1 is a schematic block diagram of a system having a memory system according to an implementation of the present disclosure;

FIGS. 2A and 2B are schematic block diagrams of memory systems according to implementations of the present disclosure;

FIG. 3 is a schematic block diagram of a memory device according to an implementation of the present disclosure;

FIG. 4 is a schematic diagram of the circuit of a memory cell array according to an implementation of the present disclosure;

FIG. 5 is a schematic structural diagram of a memory cell string according to an implementation of the present disclosure;

FIG. 6 is a schematic timing diagram of a read operation according to an implementation of the present disclosure;

FIG. 7 is a schematic timing diagram of a read operation according to another implementation of the present disclosure; and

FIG. 8 is a schematic flowchart of an operating method for a memory device according to an implementation of the present disclosure.

### DETAILED DESCRIPTION

For a better understanding of the present disclosure, various aspects of the present disclosure will be described in more detail with reference to the drawings. It should be understood that these detailed descriptions are only for the purpose of explaining exemplary implementations of the present disclosure and are not intended to limit the scope of the present disclosure in any way. Throughout the specification, identical reference numerals refer to identical elements. The expression “and/or” includes any and all combinations of one or more of the associated listed items.

It should be noted that in this specification, the expressions first, second, third, etc., are only used to distinguish one feature from another and do not represent any limitation of features, in particular any precedence. Thus, a first read command discussed in this specification may also be referred to as a second read command, and vice versa, without departing from the teachings of the present disclosure.

In the figures, thicknesses, dimensions, and shapes of components have been somewhat adjusted for easy illustration. The figures are only exemplary and not strictly drawn to scale. For example, as used herein, the terms “approximate”, “about”, and the like indicate approximation instead of degrees and are intended to mean inherent variations in measured or calculated values as realized by those of ordinary skill in the art.

It should also be understood that terms such as terms “include”, “comprise”, “have”, and/or “contain” are open rather than closed expressions in this specification and they indicate the presence of the stated features, elements, and/or components but do not exclude the presence of one or more other features, elements, components, and/or combinations thereof. Furthermore, when the expression “at least one of” precedes a list of listed features, it modifies all the listed features instead of any individual ones. Furthermore, when used in the description of an implementation of the present disclosure, the term “may” indicates “one or more implementations of the present disclosure”. Also, the term “illustratively” means exemplarily or by way of example.

All the terms (including engineering terms and scientific and technical terms) used herein have the same meanings as those commonly understood by those of ordinary skill in the art to which the present disclosure belongs, unless otherwise specified. It should also be understood that the words defined in commonly-used dictionaries should be construed as having meanings consistent with their meanings in the context of the relevant technology and should not be construed as idealized or overly formal meanings, unless otherwise specified explicitly in the present disclosure.

It should be noted that the implementations of the present disclosure and features in the implementations may be combined in the case where there are no conflicts. Moreover, the specific steps in the method described herein are not necessarily limited to the order described but may be performed in any order or in parallel unless expressly defined or contrary to the context.

The present disclosure will be described in detail hereafter in connection with implementations with reference to the drawings.

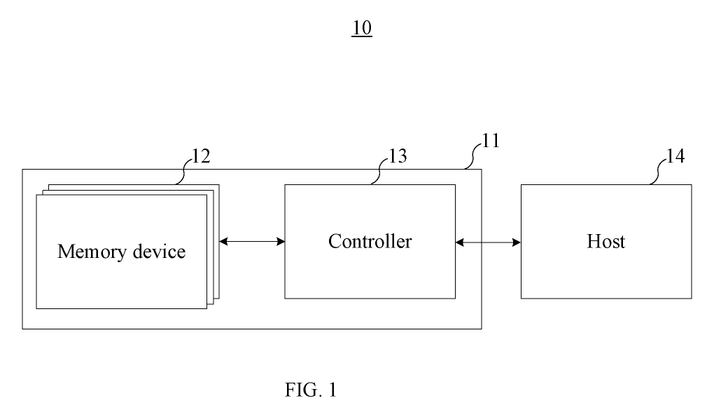

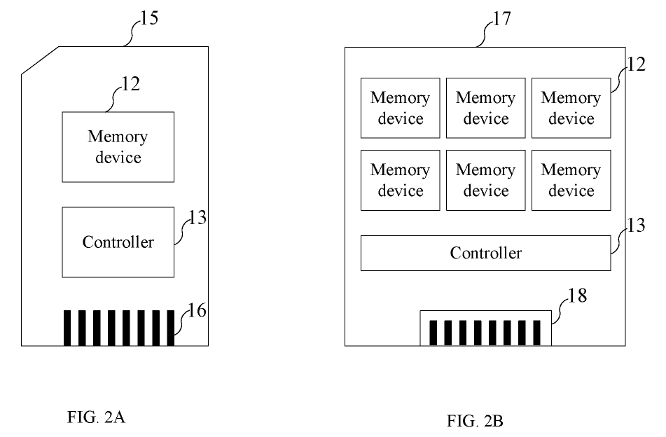

FIG. 1 illustrates a schematic block diagram of a system having a memory system according to an implementation of the present disclosure. FIGS. 2A and 2B illustrate schematic block diagrams of memory systems according to implementations of the present disclosure.

As shown in FIG. 1, the system 10 may be a mobile phone, a desktop computer, a laptop computer, a tablet computer, a vehicle-mounted computer, a game console, a printer, a positioning device, a wearable electronic device, a smart sensor, a virtual reality (VR) device, an augment reality (AR) device, or any other suitable electronic device (the electronic device having a memory system 11 located therein). The system 10 may include a host 14 and a memory system 11, and the memory system 11 may have one or more memory devices 12 and a controller 13. The host 14 may be a processor of the electronic device, such as a central processing unit (CPU), or may be a system-on-chip (SoC), such as an application processor (AP). The host 14 may be configured to send or receive data to or from the memory device 12.

The memory device 12 may be the memory device of any of the implementations of the present disclosure mentioned below. The controller 13 is coupled to the memory device 12 and the host 14 and is configured to control operations of the memory device 12, such as read, erase, and program operations. For example, the controller 13 may be configured to communicate with the memory device 12 using command sets compliant with the ONFI and Toggle flash memory standards. In some implementations, the controller 13 may also be configured to manage various functions related to data stored in the memory device 12 or to be stored in the memory device 12, including but not limited to bad block management, garbage collection, logical-to-physical address translation, wear leveling, and the like. The controller 13 is further configured to process an error correction code (ECC) related to data read from the memory device 12 or programmed into the memory device 12. Any other suitable function may also be performed by the controller 13, such as formatting the memory device 12.

In some implementations, the controller 13 may communicate with the host 14. The controller 13 may communicate with an external device (e.g., the host 14) according to a particular communication protocol. For example, the controller 13 may communicate with an external device through at least one of various interface protocols, such as a USB protocol, an MMC protocol, a peripheral component interconnect (PCI) protocol, a PCI-express (PCI-E) protocol, an advanced technology attachment (ATA) protocol, a serial ATA protocol, a parallel ATA protocol, a small computer system interface (SCSI) protocol, an enhanced small disk interface (ESDI) protocol, an integrated drive electronics (IDE) protocol, and a Firewire protocol.

In some implementations, the controller 13 is designed to operate in low-duty-cycle environments, such as a secure digital (SD) card, a compact flash (CF) card, a universal serial bus (USB) flash drive, or other media used in electronic devices such as personal computers, digital cameras, and mobile phones. In other implementations, the controller 13 is designed to operate in high-duty-cycle environments, such as a solid state disk (SSD) or an embedded multi-media-card (eMMC) used as a data memory device for mobile devices (such as smart phones, tablet computers, and laptop computers), as well as an enterprise storage array.

In some implementations, the controller 13 and the one or more memory devices 12 may be integrated into various types of memory systems, for example, included in the same package (such as a universal flash storage (UFS) package or an eMMC package). That is, the memory system 11 may be implemented and packaged into different types of end electronic products. In one example as shown in FIG. 2A, the controller 13 and a single memory device 12 may be integrated into a memory card 15. The memory card 15 may include a PC card (PCMCIA, personal computer memory card international association), a CF card, a smart media (SM) card, a memory stick, a multimedia card (MMC, RS-MMC, or MMCmicro), an SD card (SD, miniSD, microSD, or SDHC), a UFS, and the like. The memory card 15 may further include a memory card connector 16 coupling the memory card 15 with a host (e.g., the host 14 in FIG. 1). In another example as shown in FIG. 2B, the controller 13 and a plurality of memory devices 12 may be integrated into an SSD 17. The SSD 17 may further include an SSD connector 18 coupling the SSD 17 with a host (e.g., the host 14 in FIG. 1). In some implementations, the storage capacity and/or the operation speed of the SSD 17 are greater than those of the memory card 15.

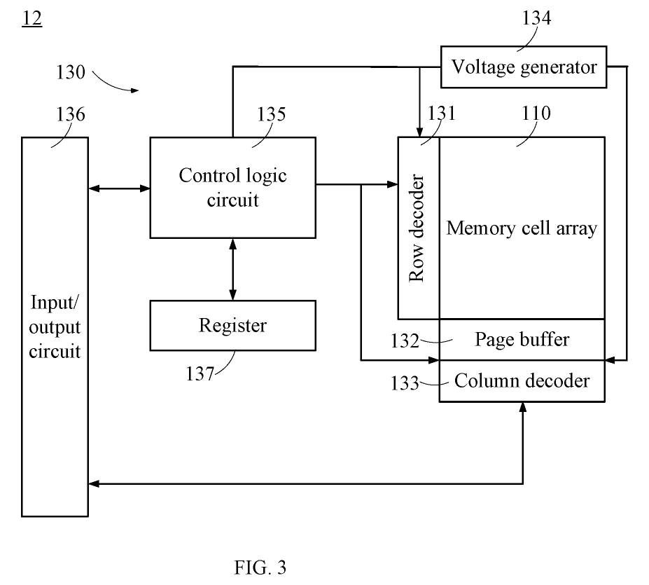

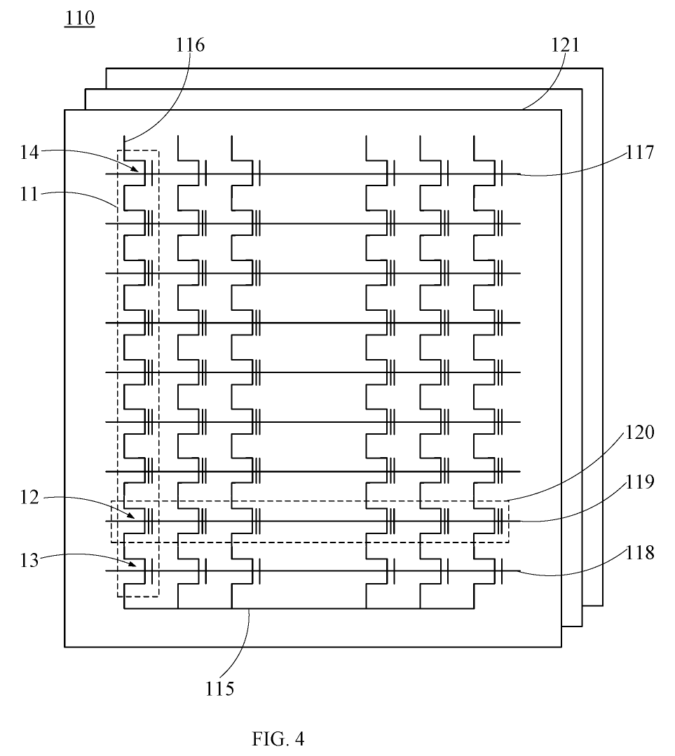

FIG. 3 illustrates a schematic block diagram of a memory device according to an implementation of the present disclosure. FIG. 4 illustrates a schematic diagram of the circuit of a memory cell array according to an implementation of the present disclosure.

As shown in FIG. 3, the memory device 12 may include a memory cell array 110 and a peripheral circuit 130 coupled to the memory cell array 110. For example, the memory cell array 110 may be a NAND flash memory cell array. As shown in FIG. 4, a memory cell 112 is provided in a memory cell string 111. The memory cell string 111 may include a plurality of memory cells 112 coupled in series. The memory cell 112 may be a memory cell including a floating-gate type transistor or a memory cell including a charge-trapping type transistor.

In some implementations, the memory cell 112 may be a single-level cell (SLC) having two possible states and capable of storing one bit of data. In other implementations, the memory cell 112 may be a multi-level cell having more than two possible states and capable of storing more than one bit of data. For example, a multi-level cell (MLC) may have four possible states and may store two bits of data; a triple-level cell (TLC) may have eight possible states and may store three bits of data; a quad-level cell (QLC) may have sixteen possible states and may store four bits of data. Generally, a multi-level cell may have 2ⁿ possible states and may store n bits of data, where n is an integer. For example, n equals 2, 3, and 4 for MLC, TLC, and QLC, respectively.

In some implementations, as shown in FIG. 4, the memory cell string 111 may further include a source selective gate (SSG) transistor 113 at one end (e.g., a source end) thereof and a drain selective gate (DSG) transistor 114 at the other end (e.g., a drain end) thereof. The SSG transistor 113 and the DSG transistor 114 may be configured to activate the selected memory cell string 111 during read and program operations.

In some implementations, a plurality of memory cell strings 111 may be organized into a memory block 121. A plurality of memory blocks 121 may be organized into a memory plane (not shown). A plurality of memory planes may be organized into a die. For example, a die may be the smallest basic management unit for the memory device 12 to communicate with the controller 13 (see FIG. 1). The memory device 12 may include one or more dies.

In some implementations, the sources of the memory cell strings 111 in the same memory block 121 may be coupled through the same source line (SL) 115. In other words, all the memory cell strings 111 in the same memory block 121 may have an array common source (ACS).

In some implementations, the drain of each memory cell string 111 may be coupled to a corresponding bit line 116, and data may be read from or written (programmed) into the bit line 116 via an output bus (not shown). The plurality of memory cell strings 111 arranged in columns may be respectively coupled to different bit lines 116.

In some implementations, each memory cell string 111 may be configured to apply a select voltage to the gate of the corresponding DSG transistor 114 or disable the select voltage via the DSG line 117 and/or to apply a select voltage to the gate of the corresponding SSG transistor 113 or disable the select voltage via the SSG line 118. The memory cell string 111 may thus become a selected memory cell string or an unselected memory cell string.

In some implementations, the memory cells 112 in the same layer in different memory cell strings 111 may be coupled by a word line 119. In other words, all memory cells 112 coupled to the same word line 119 may constitute a row storage unit 120. The row storage unit 120 may correspond to one or more storage pages. Different row storage units 120 may be respectively coupled to different word lines 119. Each word line 119 may be configured to apply a word line program voltage or a pass voltage and thus may become a selected word line or an unselected word line.

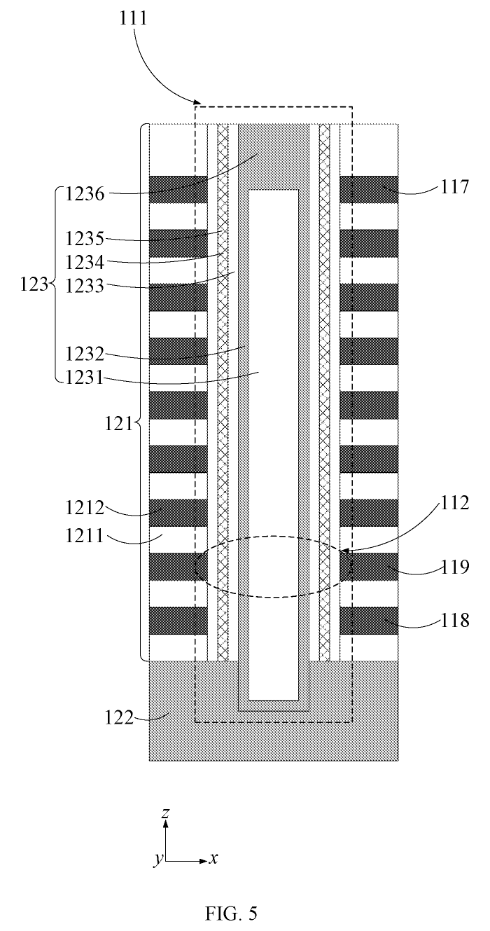

FIG. 5 illustrates a schematic structural diagram in which a memory cell string is included according to an implementation of the present disclosure. As shown in FIGS. 4 and 5, the memory cell string 111 may include a channel structure 123 perpendicularly extending and penetrating through a stacked structure 121 above a semiconductor layer 122. The material of the semiconductor layer 122 may include silicon (e.g., monocrystalline silicon), silicon germanium, gallium arsenide, germanium, or any other suitable semiconductor material. The semiconductor layer 122 may serve as an ACS for one memory block 121.

It should be noted that the x axis, y axis, and z axis shown in FIG. 5 are used to further illustrate the spatial relationship of the various components of the memory device. The semiconductor layer 122 may include two surfaces extending in a plane defined by the x axis and the y axis. The z axis is perpendicular to the x axis and the y axis. When the semiconductor layer 122 is located in the lowest plane of the memory device in the z direction, whether a component (e.g., a layer or structure) of the memory device is “on”, “above”, “under”, or “below” another component (e.g., a layer or structure) in the z direction is determined with respect to the semiconductor layer 122. The same concept will be used in the present disclosure to describe the spatial relationship of various components of the memory device.

The stacked structure 121 may include dielectric layers 1211 and conductive layers 1212 alternately arranged. The number of the pairs of the dielectric layer 1211 and the conductive layer 1212 can be used to determine the number of memory cells 112 in the memory cell array 110. The material of the dielectric layer 1211 may include silicon oxide, silicon nitride, silicon oxynitride, or any other suitable insulating material. For example, the material of the dielectric layer 1211 may be silicon oxide. The material of the conductive layer 1212 may include one or more of titanium, titanium nitride, tantalum, tantalum nitride, polysilicon, amorphous silicon, tungsten, molybdenum, copper, aluminum, ruthenium, or any other suitable conductive material. For example, the material of the conductive layer 1212 may include tungsten. Each conductive layer 1212 may include the gate of the DSG transistor 114, the gate of the SSG transistor 113, or the gate of the memory cell 112, and may extend as the DSG line 117 in the upper portion of the stacked structure 121, as the SSG line 118 in the lower portion of the stacked structure 121, or as the word line 119 in the middle portion of the stacked structure 121.

It should be noted that although one SSG line 118 and one DSG line 117 are illustrated in FIGS. 4 and 5, the number of the SSG lines 118 and the number of the DSG lines 117 (and the number of the SSG transistors 113 and the DSG transistors 114 coupled to the SSG lines 118 and DSG lines 117, respectively) may vary in other examples, and this is not specifically limited in the present disclosure.

In some implementations, as shown in FIG. 5, the channel structure 123 may be substantially columnar (e.g., cylindrical). The channel structure 123 may include an insulating pillar 1231, a channel layer 1232, a tunneling layer 1233, a charge trapping layer 1234, and a blocking layer 1235. The insulating pillar 1231 may extend in the z direction and extend into the semiconductor layer 122. The channel layer 1232, the tunneling layer 1233, the charge trapping layer 1234, and the blocking layer 1235 are arranged in sequence in a radial direction away from the insulating pillar 1231. In other words, the channel layer 1232 may surround the insulating pillar 1231, the tunneling layer 1233 may surround the channel layer 1232, the charge trapping layer 1234 may surround the tunneling layer 1233, and the blocking layer 1235 may surround the charge trapping layer 1234. For example, the channel layer 1232 may extend into the semiconductor layer 122, and the tunneling layer 1233, the charge trapping layer 1234, and the blocking layer 1235 may extend only in the stacked structure 121 but not into the semiconductor layer 122.

In some implementations, the material of the insulating pillar 1231 may include one or more of silicon oxide, silicon nitride, silicon oxynitride, or any other suitable insulating material. The material of the channel layer 1232 may include one or more of polysilicon, amorphous silicon, silicon germanium, or any other suitable semiconductor material. The materials of the tunneling layer 1233, the charge trapping layer 1234, and the blocking layer 1235 may include silicon oxide, silicon nitride, and silicon oxide, respectively.

In some implementations, a portion of the channel structure 123 surrounded by the conductive layer 1212 and a portion of the conductive layer 1212 may constitute one memory cell 112, SSG transistor 113, or DSG transistor 114. The memory cell 112 may be a memory cell including a charge-trapping type transistor. As described above, other portions of the conductive layer 1212 may serve as the word line 119, the SSG line 118, or the DSG line 117. In one memory cell string 111, a plurality of memory cells 112 may share the channel layer 1232.

In some implementations, as shown in FIGS. 4 and 5, the channel structure 123 may further include a channel plug 1236. The channel plug 1236 may be located above the insulating pillar 1231 and, for example, be surrounded by the channel layer 1232. The material of the channel plug 1236 may include one or more of polysilicon, amorphous silicon, silicon germanium, or any other suitable semiconductor material. For example, the channel plug 1236 may serve as the drain of the memory cell string 111. For example, the channel plug 1236 may be coupled to the bit line 116.

It should be noted that the structure of the memory cell string 111 shown in FIG. 5 is for illustration purposes only and may be varied in other examples.

In some implementations, referring again to FIG. 3, the peripheral circuit 130 may include any suitable digital, analog, and/or mixed-signal functional circuits for supporting the functions of the memory cell array 110, such as a row decoder (or referred to as a word line driver) 131, a column decoder (or referred to as a bit line driver) 133, a page buffer (or referred to as a sense amplifier) 132, a voltage generator 134, a control logic circuit 135, an input/output (I/O) circuit 136, and a register 137. For example, the functional circuit described above may include one or more of any active or passive devices (e.g., transistors, diodes, resistors, or capacitors). It should be noted that in some examples, the peripheral circuit 130 may further include an additional peripheral circuit not shown in FIG. 3, such as a busy/ready circuit.

As shown in FIGS. 3 and 4, the control logic circuit 135 may be configured to receive various commands (e.g., a read command, a write command, or an erase command) in a flash command set and various enable signals (e.g., a chip enable signal, a command latch signal, or an address latch signal) from the controller 13 (see FIG. 1) and generate various control signals. The control logic circuit 135 may also be configured to send various state signals to the controller 13 (see FIG. 1).

For example, the control logic circuit 135 may include one or more logic control units. The logic control unit may be a software module and/or a firmware module running on a processor (e.g., a microprogrammed control unit (MCU)) of part of the control logic circuit 135, or may be a hardware module of a finite state machine (FSM), such as an integrated circuit (e.g., an application specific integrated circuit (ASIC) or a field-programmable gate array (FPGA)), or may be a combination of a software module, a firmware module, and a hardware module.

The row decoder 131 may be configured to control a selected or unselected word line 119 in response to a control signal from the control logic circuit 135. The row decoder 131 may be further configured to drive the word line 119 using a word line voltage (e.g., a word line program voltage or a pass voltage) generated from the voltage generator 134. In some implementations, the row decoder 131 may also use the SSG voltage and the DSG voltage generated from the voltage generator 134 to select or deselect the SSG line 118 and the DSG line 117.

The column decoder 133 may be configured to control a selected or unselected memory cell string 111 via the bit line 116 in response to a control signal from the control logic circuit 135. The column decoder 133 may be further configured to drive the bit line 116 using the bit line voltage (e.g., a bit line program voltage or a bit line inhibit voltage) generated from the voltage generator 134.

The page buffer 132 may be configured to read data from the memory cell array 110 or program (write) data to the memory cell array 110 in response to a control signal from the control logic circuit 135. In one example, the page buffer 132 may store data to be programmed to one storage page or a partial storage page of the memory cell array 110. In another example, the page buffer 132 may sense a low-power signal of data stored in memory cells of the memory cell array 110 in the process of performing a read operation and amplify a small voltage swing to an identifiable logic level.

The voltage generator 134 may be configured to generate, in response to control signals from the control logic circuit 135, various voltages to be supplied to the memory cell array 110, such as word line voltages (e.g., word line program voltage and pass voltage), bit line voltages (bit line program voltage and bit line inhibit voltage), SSG voltages, and DSG voltages.

The input/output circuit 136 may transmit data sent to and from the page buffer 132 via a data bus and transmit various commands in the flash command set and various enable signals from the controller 13 (see FIG. 1) to the control logic circuit 135.

The register 137 may be coupled to the control logic circuit 135 and may include a state register, a command register, an address register, etc., for storing signals indicating the operating state, the command opcode, and the command address.

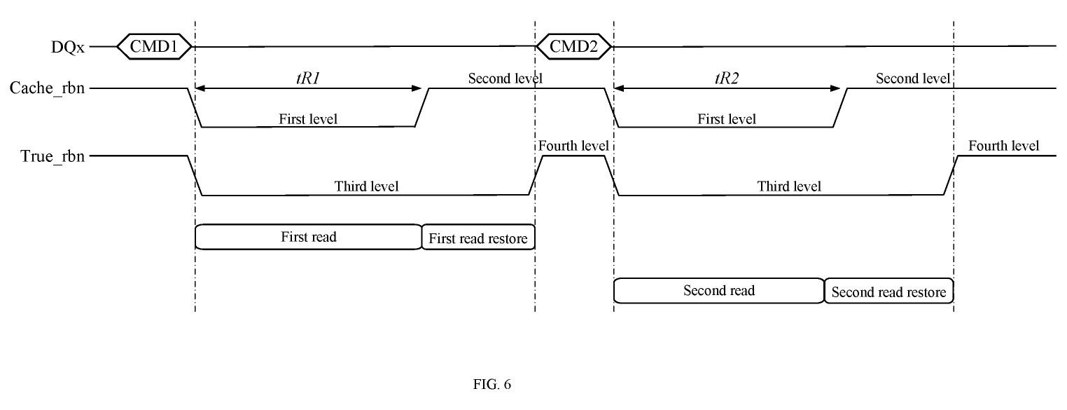

FIG. 6 illustrates a schematic timing diagram of a read operation according to an implementation of the present disclosure. The working process of the memory device 12 performing read operations consecutively in this implementation will be described below.

As shown in FIGS. 1-6, a first read operation and a first read restore operation may be performed in sequence in response to receiving the first read command CMD1. Subsequently, a second read command CMD2 is received in response to completing the first read restore operation. Next, a second read operation and a second read restore operation are performed in sequence in response to receiving the second read command CMD2.

A first indicator signal Cache_rbn remains at a first level in the process of performing the first read operation. When the first read operation is completed, the first indicator signal Cache_rbn changes from the first level to a second level. The first indicator signal Cache_rbn remains at the second level in the process of performing the first read restore operation and receiving the second read command CMD2. When the receiving of the second read command CMD2 is completed, the first indicator signal Cache_rbn changes from the second level to the first level. When the second read operation is completed, the first indicator signal Cache_rbn changes from the first level to the second level.

A second indicator signal True_rbn remains at a third level in the process of performing the first read operation and the first read restore operation. When the first read restore operation is completed, the second indicator signal True_rbn changes from the third level to a fourth level. The second indicator signal True_rbn remains at the fourth level in the process of receiving the second read command CMD2. When the receiving of the second read command CMD2 is completed, the second indicator signal True_rbn changes from the fourth level to the third level.

The first indicator signal Cache_rbn, as a state signal, may indicate that the page buffer 132 is in a ready state or a busy state. The first indicator signal Cache_rbn may be sent to the controller 13 to inform the controller 13 of the state of the page buffer 132. For example, in the case where a read operation is performed in units of a storage page or a partial storage page, when data read from the storage page or the partial storage page has not been completely buffered in the page buffer 132 and the controller 13 is not allowed to access the data buffered in the page buffer 132, the first indicator signal Cache_rbn is at the first level. In this case, the controller 13 considers the memory device 12 to be in a busy state. When data read from the storage page or the partial storage page has been completely buffered in the page buffer 132 and the controller 13 is allowed to access the data buffered in the page buffer 132, the first indicator signal Cache_rbn is at the second level. In this case, the controller 13 considers the memory device 12 to be in a ready state.

The second indicator signal True_rbn, as another state signal, may indicate that the memory device 12 (e.g., a memory plane) is in a ready state or a busy state. For example, the second indicator signal True_rbn may be sent to the controller 13 to inform the controller 13 of the operating state of the memory device 12 (e.g., a memory plane). When the memory plane is in an operating state (e.g., in the process of performing a read operation and a read restore operation), the memory device 12 may not receive other commands, and the second indicator signal True_rbn is at the third level. In this case, the controller 13 considers the memory device 12 to be in a busy state. When the memory device 12 is not in an operating state, e.g., the memory device 12 (e.g., a memory plane) may be receiving commands, the second indicator signal True_rbn is at the fourth level. The controller 13 considers the memory device 12 to be in a ready state.

In some implementations, the first indicator signal Cache_rbn and the second indicator signal True_rbn may be generated by the peripheral circuit (e.g., a busy/ready circuit), stored in the state register of the peripheral circuit 130, and sent to the controller 13 in real time. When the controller 13 detects that the second indicator signal True_rbn changes from the third level to the fourth level, the controller 13 may send the second read command CMD2 to the memory device 12. Meanwhile, since the second indicator signal True_rbn has been changed to the fourth level in the memory device 12, the memory device 12 allows the receiving of the second read command CMD2.

In this implementation, when the memory device 12 performs the read operations consecutively, the first read operation, the first read restore operation, the receiving of the second read command, the second read operation, and the second read restore operation are sequentially performed. Thus, the time of two consecutive read operations may be the sum of the time tR1 of the first read operation, the time of the first read restore operation, the time of the receiving of the second read command, and the time tR2 of the second read operation. As the number of memory cells in the memory cell string increases, the read restore operation will take longer, which is disadvantageous to the improvement of the read speed of the consecutive read operations and affects the efficiency of the consecutive read operations.

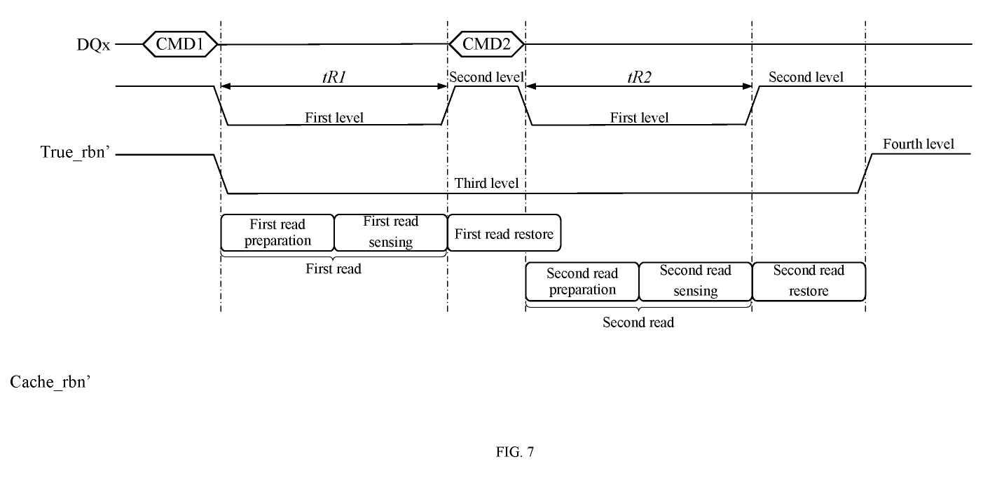

The present disclosure provides a memory device with improved speed and efficiency in consecutive reading through an optimized configuration scheme for peripheral circuits. FIG. 7 illustrates a schematic timing diagram of a read operation according to another implementation of the present disclosure. The working process of the memory device 12 performing read operations consecutively in this implementation will be described below with reference to FIGS. 1-5.

As shown in FIGS. 1-5 and FIG. 7, in response to an input/output circuit 136 receiving a first read command CMD1 from a controller 13, the input/output circuit 136 transmits the first read command CMD1 to a control logic circuit 135. For example, the first read command CMD1 may include address information for a row address and a column address. Illustratively, the controller 13 issues a read command “00h” and sends the read command to the control logic circuit 135 via the input/output circuit 136. The read command “00h” may be equivalent to a command for receiving an address input for reading. Next, the controller 13 may send address information including a row address and a column address of a specific storage page or partial storage page to the control logic circuit 135. Then, the controller 13 may issue a read start command “20h” and send the read start command to the control logic circuit 135 to instruct to start the read process based on the read start command and the address information.

Next, the control logic circuit 135 may generate a corresponding control signal based on the address information of the row address and the column address described above. In response to the control signal, a row decoder 131 and a column decoder 133 apply a driving voltage to the corresponding word line 119 and bit line 116 to perform a first read operation.

It should be noted that in the case where the address signal includes a partial storage page, the read operation may be performed in a 4k random read mode. The 4k random read refers to randomly reading the data in the memory cell array in units of 4 kb in each data read operation. This reading method is often used to test random read performance or is applied when dealing with large numbers of small files or large files stored discontinuously.

In some implementations, the first read operation may include a first read preparation operation and a first read sensing operation. In other words, in the process of performing the first read operation, the first read preparation operation and the first read sensing operation may be performed in sequence. The first read preparation operation may include command determination, address processing, voltage calculation, timing calculation, and the like. During the first read preparation operation, the corresponding word line 119 and bit line 116 have not yet been applied with a voltage and are, for example, maintained at the respective read preparation voltages. The first read sensing operation may be an operation of determining the data state of a selected memory cell in a memory cell string 111 by sensing the current flowing through the memory cell string. The memory cell string in which the selected memory cell is located may be referred to as a selected memory cell string.

In some implementations, in the process of performing the first read sensing operation, the selected bit line may be a bit line coupled to a memory cell string in which the selected memory cell is located. The selected word line may be a word line corresponding to a storage page in which the selected memory cell is located. The unselected word lines may be other word lines except for the selected word line.

In some implementations, firstly, the column decoder 133 may apply a charging voltage to a selected bit line in response to a control signal from the control logic circuit 135; then, the row decoder 131 may apply a read voltage to a selected word line and a pass voltage to unselected word lines in response to a control signal from the control logic circuit 135, enabling connection with the selected bit line and the source line 115. For example, the pass voltage is greater than the read voltage. Meanwhile, the DSG transistor 114 is controlled by the DSG line 117 to be in a conducting state, and the SSG transistor 113 is controlled by the SSG line 118 to be in a cutoff state. The data state of the selected memory cell is determined by the magnitude of the current flowing through the channel (e.g., the channel layer 1232 shown in FIG. 5) of the selected memory cell string.

The read voltage is defined between adjacent data states. If the read voltage is lower than the threshold voltage of the selected memory cell, the selected memory cell string cannot conduct, and almost no current flows through the selected memory cell string, such that it can be determined that the selected memory cell is in a data state lower than the read voltage. If the read voltage is higher than the threshold voltage of the selected memory cell, the selected memory cell string conducts, and there is a conduction current in the selected memory cell string, such that it can be determined that the selected memory cell is in a data state higher than the read voltage.

After the first read operation (e.g., the first read sensing operation) is completed, a first read restore operation is performed. For example, the voltages of, for example, the selected bit line, the selected word line, the unselected word lines, the DSG line, and the SSG line may be controlled to be restored to the respective read preparation voltages in response to the control signals from the control logic circuit 135 to perform the next read operation. Meanwhile, when the first read operation is completed, the data of the storage page or the partial storage page has been buffered in a page buffer 132, and the controller 13 is allowed to access the data in the page buffer 132. For example, in the process where the memory device 12 sends the data to the controller 13, the memory device 12 performs a first read restore operation.

The memory device 12 may receive a second read command CMD2 in response to completing the first read operation (e.g., the first read sensing operation). Illustratively, in response to the input/output circuit 136 receiving the second read command CMD2 from the controller 13, the input/output circuit 136 may transmit the second read command CMD2 to the control logic circuit 135. For example, the second read command CMD2 may include a row address and a column address. The address information of the row address and the column address included in the second read command CMD2 may be different from the address signals included in the first read command CMD1. The process of receiving the second read command CMD2 by the memory device 12 is similar to the process of receiving the first read command CMD1, and since the process of receiving the first read command CMD1 by the memory device 12 has been described in detail above, the details will not be repeated here in the present disclosure.

The memory device 12 may perform a second read operation in response to the memory device 12 receiving the second read command CMD2. For example, the control logic circuit 135 may generate a corresponding control signal based on the address information of the row address and the column address included in the second read command CMD2. In response to the control signal, the row decoder 131 and the column decoder 133 apply a driving voltage to the corresponding word line 119 and bit line 116 to perform the second read operation.

Compared with the previous implementation, in this implementation, receiving the second read command is not dependent on the completion of the first read restore operation. When the first read operation is completed, the memory device may receive the second read command immediately and perform the second read operation based on the second read command. In other words, the first read operation, the receiving of the second read command, and the second read operation are sequentially performed. Thus, the time of two consecutive read operations may be the sum of the time tR1 of the first read operation, the time of the receiving of the second read command, and the time tR2 of the second read operation. Compared with the previous implementation, in this implementation, the time of the consecutive read operations is shortened, contributing to the improvement of the speed and efficiency of consecutive read operations.

In some implementations, the second read operation may include a second read preparation operation and a second read sensing operation. In other words, in the process of performing the second read operation, the second read preparation operation and the second read sensing operation may be performed in sequence. Similar to the first read preparation operation, the second read preparation operation may include command determination, address processing, voltage calculation, timing calculation, and the like. During the second read preparation operation, the corresponding word line 119 and bit line 116 have not yet been applied with a voltage and are, for example, in the process of restoring the read preparation voltage. Similar to the first read sensing operation, the second read sensing operation may be an operation of determining the data state of a selected memory cell in a memory cell string by sensing the current flowing through the memory cell string. The process of performing the second read sensing operation by the memory device 12 is similar to the process of performing the first read sensing operation, and since the process of performing the first read sensing operation by the memory device 12 has been described in detail above, the details will not be repeated here in the present disclosure.

In some practical applications, the time for receiving the second read command CMD2 tends to be short, while the time for the first read restore operation is longer as the number of memory cells in the memory cell string increases. As such, the process of the second read preparation operation preferentially performed in the second read operation may partially overlap with the process of the first read restore operation. In other words, the first read restore operation and the second read preparation operation may be performed in parallel for a period of time. Since no voltage has yet been applied to the corresponding word line and bit line during the second read preparation operation, the first read restore operation and the second read preparation operation do not affect each other.

In some implementations, after the second read operation is performed, a second read restore operation may be performed. For example, the voltages of, for example, the selected bit line, the selected word line, the unselected word lines, the DSG line, and the SSG line may be controlled to be restored to the respective read preparation voltages in response to the control signals from the control logic circuit 135.

In some implementations, the peripheral circuit 130 may be configured to determine (e.g., generate) a first indicator signal Cache_rbn'. In the process of performing the first read operation, the first indicator signal Cache_rbn' remains at a first level. When the first read operation is completed, the first indicator signal Cache_rbn' changes from the first level to a second level. Optionally, the first indicator signal Cache_rbn' remains at the second level in the process of receiving the second read command CMD2. When the receiving of the second read command CMD2 is completed, the first indicator signal Cache_rbn' changes from the second level to the first level. Optionally, the first indicator signal Cache_rbn' remains at the second level in the process of performing the second read operation. When the second read operation is completed, the first indicator signal Cache_rbn' changes from the first level to the second level.

It should be noted that the changing between the first level and the second level may require a changing time. The time when the first read operation is completed refers to the start time for the change from the first level to the second level. The time when the receiving of the second read command CMD2 is completed (or the time when the second read command CMD2 is received) refers to the end time for the change from the second level to the first level. The time when the receiving of the second read command CMD2 is completed is equivalent to the start time for performing the second read operation. The first indicator signal Cache_rbn' may indicate that the page buffer 132 is in a ready state or a busy state. The first indicator signal Cache_rbn' may be sent to the controller 13 to inform the controller 13 of the state of the page buffer 132. For example, in the case where a read operation is performed in units of a storage page or a partial storage page, when data read from the storage page or the partial storage page has not been completely buffered in the page buffer 132 and the controller 13 is not allowed to access the data buffered in the page buffer 132, the first indicator signal Cache_rbn' is at the first level. In this case, the controller 13 considers the memory device 12 to be in a busy state. When data read from the storage page or the partial storage page has been completely buffered in the page buffer 132 and the controller 13 is allowed to access the data buffered in the page buffer 132, the first indicator signal Cache_rbn' is at the second level. In this case, the controller 13 considers the memory device 12 to be in a ready state.

Furthermore, the first indicator signal Cache_rbn' may also indicate the state with respect to command receiving. When the first indicator signal Cache_rbn' indicates that the memory device 12 is in a busy state, the memory device 12 (e.g., a memory plane) does not receive other commands. When the first indicator signal Cache_rbn' indicates that the memory device 12 is in a ready state, the memory device 12 (e.g., a memory plane) may receive other commands. Compared with the first indicator signal Cache_rbn in the previous implementation, in this implementation, the first indicator signal Cache_rbn' is also used to indicate the state with respect to whether a command can be received in addition to indicating the state of the page buffer 132.

It should be noted that, in the above implementation, the first indicator signal Cache_rbn' is described by taking the page buffer 132’s buffering the data read from the memory cell array 110 as an example. In other implementations, the peripheral circuit 130 of the memory device 12 may further include a data register or a cache latch to buffer data read from the memory cell array 110. As such, the first indicator signal Cache_rbn' may indicate that the data register or the cache latch is in a ready state or a busy state.

In some implementations, the controller 13 may receive the first indicator signal Cache_rbn' in real time. When the controller 13 detects that the first indicator signal Cache_rbn' changes from the first level to the second level, the controller 13 may send the second read command CMD2 to the memory device 12. Meanwhile, since the first indicator signal Cache_rbn' in the memory device 12 has changed to the second level, the memory device 12 is allowed to receive the second read command CMD2.

In some implementations, the first level may be lower than the second level. In other words, between the first level and the second level, the first level may be a low level and the second level may be a high level. As such, the first indicator signal Cache_rbn' indicates a busy state with a low level and indicates a ready state with a high level. In other implementations, the first level may be higher than the second level. The first indicator signal Cache_rbn' may indicate a busy state with a high level and indicate a ready state with a low level. This is not specifically limited in the present disclosure.

In some implementations, the peripheral circuit 130 may be configured to determine (e.g., generate) a second indicator signal True_rbn'. In the process of performing the first read operation, the first read restore operation, the second read operation, and the second read restore operation, the second indicator signal True_rbn' remains at a third level. When the second read restore operation is completed, the second indicator signal True_rbn' changes from the third level to a fourth level.

The second indicator signal True_rbn' may indicate that the memory device 12 (e.g., a memory plane) is in a ready state or a busy state. For example, the second indicator signal True_rbn' may be sent to the controller 13 to inform the controller 13 of the operating state of the memory device 12 (e.g., a memory plane). When the memory device 12 (e.g., a memory plane) is in an operating state (e.g., in the process of performing a read operation and a read restore operation), the second indicator signal True_rbn' is at the third level. In this case, the controller 13 considers the memory device 12 to be in a busy state. When the memory device (e.g., a memory plane) is not in an operating state, the second indicator signal True_rbn' is at the fourth level. In this case, the controller 13 considers the memory device 12 to be in a ready state.

In some implementations, the third level may be lower than the fourth level. In other words, between the third level and the fourth level, the third level may be a low level and the fourth level may be a high level. As such, the second indicator signal True_rbn' indicates a busy state with a low level and indicates a ready state with a high level. In other implementations, the third level may be higher than the fourth level. The second indicator signal True_rbn' may indicate a busy state with a high level and a ready state with a low level. This is not specifically limited in the present disclosure.

In some implementations, the read scheme described in detail above may be performed by one of a plurality of memory planes in the same die individually or performed by a plurality of memory planes synchronously or asynchronously to improve read throughput, thereby resulting in high chip throughput. Therefore, the read scheme can adapt to different read operation modes to have good consecutive read speed and efficiency under different operation modes.

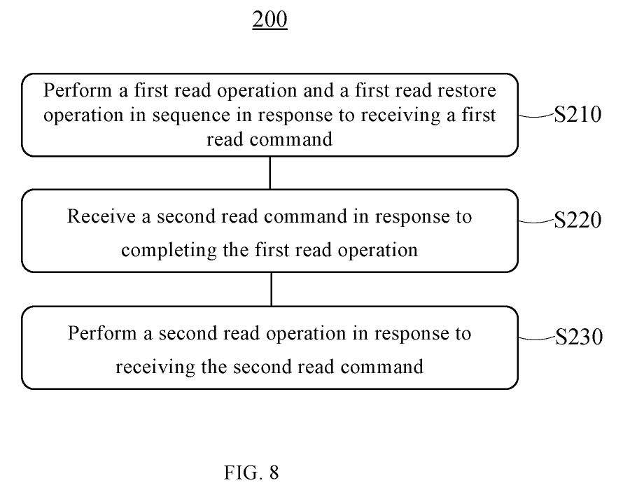

FIG. 8 illustrates an operating method for a memory device according to an implementation of the present disclosure. As shown in FIG. 8, the operating method 200 for a memory device may include the following steps.

In S210, a first read operation and a first read restore operation are performed in sequence in response to receiving a first read command.

In S220, a second read command is received in response to completing the first read operation.

In S230, a second read operation is performed in response to receiving the second read command.

The specific content of each step of the operating method 200 for a memory device will be described in detail below with reference to FIGS. 1-5 and FIG. 7.

In step S210, in response to the input/output circuit 136 receiving the first read command CMD1 from the controller 13, the input/output circuit 136 transmits the first read command CMD1 to the control logic circuit 135. For example, the first read command CMD1 may include address information for a row address and a column address. Illustratively, the controller 13 issues a read command “00h” and sends the read command to the control logic circuit 135 via the input/output circuit 136. The read command “00h” may be equivalent to a command for receiving an address input for reading. Next, the controller 13 may send address information including a row address and a column address of a specific storage page or partial storage page to the control logic circuit 135. Then, the controller 13 may issue a read start command “20h” and send the read start command to the control logic circuit 135 to instruct to start the read process based on the read start command and the address information.

Next, the control logic circuit 135 may generate a corresponding control signal based on the address information of the row address and the column address described above. In response to the control signal, a row decoder 131 and a column decoder 133 apply a driving voltage to the corresponding word line 119 and bit line 116 to perform a first read operation.

It should be noted that in the case where the address signal includes a partial storage page, the read operation may be performed in a 4k random read mode. The 4k random read refers to randomly reading the data in the memory cell array in units of 4 kb in each data read operation. This reading method is often used to test random read performance or is applied when dealing with large numbers of small files or large files stored discontinuously.

In some implementations, the first read operation may include a first read preparation operation and a first read sensing operation. In other words, in the process of performing the first read operation, the first read preparation operation and the first read sensing operation may be performed in sequence. The first read preparation operation may include command determination, address processing, voltage calculation, timing calculation, and the like. During the first read preparation operation, the corresponding word line 119 and bit line 116 have not yet been applied with a voltage and are, for example, maintained at the respective read preparation voltages. The first read sensing operation may be an operation of determining the data state of a selected memory cell in a memory cell string 111 by sensing the current flowing through the memory cell string. The memory cell string in which the selected memory cell is located may be referred to as a selected memory cell string.

After the first read operation (e.g., the first read sensing operation) is completed, a first read restore operation is performed. For example, the voltages of, for example, the selected bit line, the selected word line, the unselected word lines, the DSG line, and the SSG line may be controlled to be restored to the respective read preparation voltages in response to the control signals from the control logic circuit 135 to perform the next read operation. Meanwhile, when the first read operation is completed, the data of the storage page or the partial storage page has been buffered in a page buffer 132, and the controller 13 is allowed to access the data in the page buffer 132. For example, in the process where the memory device 12 sends the data to the controller 13, the memory device 12 performs a first read restore operation.

In step S220, in response to completing the first read operation (e.g., the first read sensing operation), the memory device 12 may receive the second read command CMD2. Illustratively, in response to the input/output circuit 136 receiving the second read command CMD2 from the controller 13, the input/output circuit 136 may transmit the second read command CMD2 to the control logic circuit 135. For example, the second read command CMD2 may include a row address and a column address. The address information of the row address and the column address included in the second read command CMD2 may be different from the address signals included in the first read command CMD1. The process of receiving the second read command CMD2 by the memory device 12 is similar to the process of receiving the first read command CMD1, and since the process of receiving the first read command CMD1 by the memory device 12 has been described in detail above, the details will not be repeated here in the present disclosure.

In step S230, in response to the memory device 12 receiving the second read command CMD2, the memory device 12 may perform the second read operation. For example, the control logic circuit 135 may generate a corresponding control signal based on the address information of the row address and the column address included in the second read command CMD2. In response to the control signal, the row decoder 131 and the column decoder 133 apply a driving voltage to the corresponding word line 119 and bit line 116 to perform the second read operation.

Compared with the previous implementation, in this implementation, receiving the second read command is not dependent on the completion of the first read restore operation. When the first read operation is completed, the memory device may receive the second read command immediately and perform the second read operation based on the second read command. In other words, the first read operation, the receiving of the second read command, and the second read operation are sequentially performed. Thus, the time of two consecutive read operations may be the sum of the time tR1 of the first read operation, the time of the receiving of the second read command, and the time tR2 of the second read operation. Compared with the previous implementation, in this implementation, the time of the consecutive read operations is shortened, contributing to the improvement of the speed and efficiency of consecutive read operations.

In some implementations, the second read operation may include a second read preparation operation and a second read sensing operation. In other words, in the process of performing the second read operation, the second read preparation operation and the second read sensing operation may be performed in sequence. Similar to the first read preparation operation, the second read preparation operation may include command determination, address processing, voltage calculation, timing calculation, and the like. During the second read preparation operation, the corresponding word line 119 and bit line 116 have not yet been applied with a voltage and are, for example, in the process of restoring the read preparation voltage. Similar to the first read sensing operation, the second read sensing operation may be an operation of determining the data state of a selected memory cell in a memory cell string by sensing the current flowing through the memory cell string. The process of performing the second read sensing operation by the memory device 12 is similar to the process of performing the first read sensing operation, and since the process of performing the first read sensing operation by the memory device 12 has been described in detail above, the details will not be repeated here in the present disclosure.

In some practical applications, the time for receiving the second read command CMD2 tends to be short, while the time for the first read restore operation is longer as the number of memory cells in the memory cell string increases. As such, the process of the second read preparation operation preferentially performed in the second read operation may partially overlap with the process of the first read restore operation. In other words, the first read restore operation and the second read preparation operation may be performed in parallel for a period of time. Since no voltage has yet been applied to the corresponding word line and bit line during the second read preparation operation, the first read restore operation and the second read preparation operation do not affect each other.

Although exemplary structures for a memory device and exemplary steps for a method of programming a memory device are described herein, it is understandable that one or more features may be omitted, substituted, or added based on the structure of the memory device or the programming method. Furthermore, the illustrated content is merely exemplary.

It should be understood that the various forms of processes shown above can be subjected to reordering, addition, or deletion of steps, as long as the desired results of the technical solutions disclosed herein are achieved. There is no limitation in this regard herein.

The descriptions above are merely the preferred implementations of the present disclosure and explanations of the technical principles used. It should be understood by those skilled in the art that the scope of protection claimed by the present disclosure is not limited to technical solutions resulting from particular combinations of the above-mentioned technical features, and instead should also cover any other technical solutions resulting from any combinations of the above-mentioned features and their equivalents without departing from the technical concept, for example, technical solutions resulting from substitutions of the above-mentioned features by technical features of similar functions (including but not limited to those disclosed in the present disclosure).

What is claimed is:

1. A memory device, comprising:
a memory cell array; and
a peripheral circuit coupled to the memory cell array and configured to:
perform a first read operation and a first read restore operation in sequence in response to receiving a first read command;
receive a second read command in response to completing the first read operation; and
perform a second read operation in response to receiving the second read command.

2. The memory device according to claim 1, wherein the second read operation comprises a second read preparation operation and a second read sensing operation, and the peripheral circuit is further configured to:
perform the second read preparation operation and the second read sensing operation in sequence in response to receiving the second read command, wherein a process of performing the first read restore operation partially overlaps with a process of performing the second read preparation operation.

3. The memory device according to claim 1, wherein the peripheral circuit is further configured to:
determine a first indicator signal, wherein the first indicator signal remains at a first level in a process of performing the first read operation and the second read operation and changes from the first level to a second level when the first read operation is completed, and the first indicator signal changes from the second level to the first level when the receiving of the second read command is completed.

4. The memory device according to claim 3, wherein the peripheral circuit is further configured to:
receive the second read command in response to the first indicator signal changing from the first level to the second level.

5. The memory device according to claim 3, wherein the peripheral circuit is further configured to:
perform a second read restore operation after performing the second read operation.

6. The memory device according to claim 3, wherein the first level is lower than the second level.

7. The memory device according to claim 5, wherein the peripheral circuit is further configured to:
determine a second indicator signal, wherein the second indicator signal remains at a third level in a process of performing the first read operation, the first read restore operation, the second read operation, and the second read restore operation and changes from the third level to a fourth level when the second read restore operation is completed.

8. The memory device according to claim 7, wherein the third level is lower than the fourth level.

9. A memory system, comprising:
a memory device, wherein the memory device comprises:
a memory cell array; and
a peripheral circuit coupled to the memory cell array and configured to:
perform a first read operation and a first read restore operation in sequence in response to receiving a first read command;
receive a second read command in response to completing the first read operation; and
perform a second read operation in response to receiving the second read command; and
a controller coupled to the memory device and configured to control the memory device to store data.

10. The memory system according to claim 9, wherein the second read operation comprises a second read preparation operation and a second read sensing operation, and the peripheral circuit is further configured to:
perform the second read preparation operation and the second read sensing operation in sequence in response to receiving the second read command, wherein a process of performing the first read restore operation partially overlaps with a process of performing the second read preparation operation.

11. The memory system according to claim 9, wherein the peripheral circuit is further configured to:
determine a first indicator signal, wherein the first indicator signal remains at a first level in a process of performing the first read operation and the second read operation and changes from the first level to a second level when the first read operation is completed, and the first indicator signal changes from the second level to the first level when the receiving of the second read command is completed.

12. The memory system according to claim 11, wherein the peripheral circuit is further configured to:
receive the second read command in response to the first indicator signal changing from the first level to the second level.

13. An operating method for a memory device, comprising:
performing a first read operation and a first read restore operation in sequence in response to receiving a first read command;
receiving a second read command in response to completing the first read operation; and
performing a second read operation in response to receiving the second read command.

14. The operating method according to claim 13, wherein the second read operation comprises a second read preparation operation and a second read sensing operation, and performing the second read operation in response to receiving the second read command comprises:
performing the second read preparation operation and the second read sensing operation in sequence in response to receiving the second read command, wherein a process of performing the first read restore operation partially overlaps with a process of performing the second read preparation operation.

15. The operating method according to claim 14, further comprising:
determining a first indicator signal, wherein the first indicator signal remains at a first level in a process of performing the first read operation and the second read operation and changes from the first level to a second level when the first read operation is completed, and the first indicator signal changes from the second level to the first level when the receiving of the second read command is completed.

16. The operating method according to claim 15, wherein receiving the second read command in response to completing the first read operation comprises:
receiving the second read command in response to the first indicator signal changing from the first level to the second level.

17. The operating method according to claim 15, wherein the first level is lower than the second level.

18. The operating method according to claim 15, further comprising:
performing a second read restore operation after performing the second read operation.

19. The operating method according to claim 18, further comprising:
determining a second indicator signal, wherein the second indicator signal remains at a third level in a process of performing the first read operation, the first read restore operation, the second read operation, and the second read restore operation and changes from the third level to a fourth level when the second read restore operation is completed.

20. The operating method according to claim 19, wherein the third level is lower than the fourth level.
